(19) United States
(12) Patent Application Publication
(10) Pub. No.: US 2016/0338529 A1
(43) Pub. Date: Nov. 24, 2016

(54) SPACE HEATER

(71) Applicant: Gregory Samaras, Whitestone, NY (US)

(72) Inventor: Gregory Samaras, Whitestone, NY (US)

(21) Appl. No.: 15/158,289

(22) Filed: May 18, 2016

Related U.S. Application Data
(60) Provisional application No. 62/163,186, filed on May 18, 2015.

(51) Int. Cl. A47J 36/26; F24C 5/20

(52) U.S. Cl. CPC A47J 36/26; F24C 5/20

(57) ABSTRACT

Disclosed herein is a space heater that includes a space heater that includes a main body configured to cover a gel fuel canister when received into the main body, the main body including a height and wherein a middle location along the height of the main body has a larger circumference than both a top location along the height of the main body and a bottom location along the height of the main body. A structure is disclosed located on a top of the main body configured to receive a can of foodstuff. A base is disclosed including a plurality of grip elements extending vertically from the base configured to receive a gel fuel canister.

### CROSS-REFERENCE TO RELATED APPLICATIONS

This application claims the benefit and priority to U.S. Provisional Application No. 62/163,186 filed May 18, 2015, and entitled “SPACE HEATER.”

### FIELD OF TECHNOLOGY

The subject matter disclosed herein relates generally to space heaters. More particularly, the subject matter relates to a space heater for holding ethanol gel fuel containers.

### BACKGROUND

While hunting for waterfowl, turkey, or big game animals from a blind or shooting shack or while ice fishing in a shanty or tent type enclosure, or just camping under the stars, an outdoor enthusiast may become exposed to adverse elements. In extreme cases, these elements could result in hypothermia. As such, it is often the case that an outdoor enthusiast will utilize various means for creating heat. For example, a gas, wood, fuel, kerosene or propane heating source may be utilized. Alternately, if electricity is provided, an electric space heater may provide heat in adverse conditions. However each of these heating mechanisms has drawbacks in convenience, cost, reliability and the like.

Thus, a space heater for holding ethanol gel fuel containers would be well received in the art.

### BRIEF DESCRIPTION

According to one embodiment, a space heater comprises: a main body configured to cover a gel fuel canister when received into the main body, the main body including a height and wherein a middle location along the height of the main body has a larger circumference than both a top location along the height of the main body and a bottom location along the height of the main body.

According to another embodiment, a space heater comprises: a base, the base including a plurality of grip elements extending vertically from the base, the plurality of grip elements configured to receive a gel fuel canister; and a main body extending from the base, the main body configured to cover the gel fuel canister when received on the base, the main body including a plurality of openings disposed about the main body.

According to another embodiment, a space heater comprises: a main body configured to cover a gel fuel canister when received on the main body, the main body including a plurality of openings disposed about the main body, the plurality of openings configured to change between an open and a closed state to expose the gel fuel canister; and a structure located on a top of the main body, the structure configured to receive a can of foodstuff and prevent the can of foodstuff from being removed from the top of the main body in a horizontal direction.

### BRIEF DESCRIPTION OF THE DRAWINGS

FIG. 1 depicts a perspective view of a space heater in accordance with one embodiment;

FIG. 2 depicts a perspective view of the space heater of FIG. 1 with closed openings in accordance with one embodiment;

FIG. 3 depicts an exploded view of the space heater of FIGS. 1 and 2 in accordance with one embodiment;

FIG. 4 depicts a perspective view of another space heater in accordance with one embodiment;

FIG. 5A depicts a perspective view of a base of the space heater of FIG. 3 in accordance with one embodiment; and

FIG. 5B depicts a perspective view of a main body of the space heater of FIG. 3 in accordance with one embodiment.

### DETAILED DESCRIPTION

A description of the hereinafter described embodiments of the disclosed apparatus and method are presented herein by way of exemplification and not limitation with reference to the photographs.

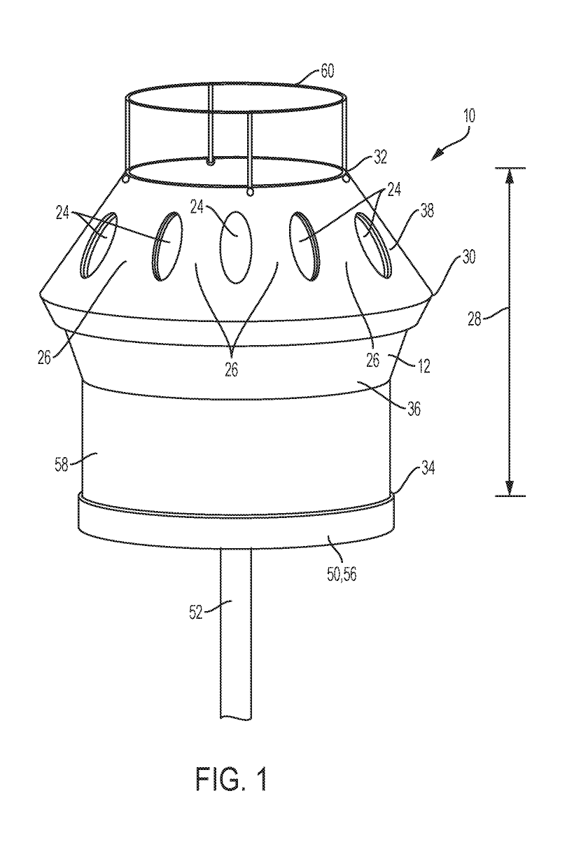

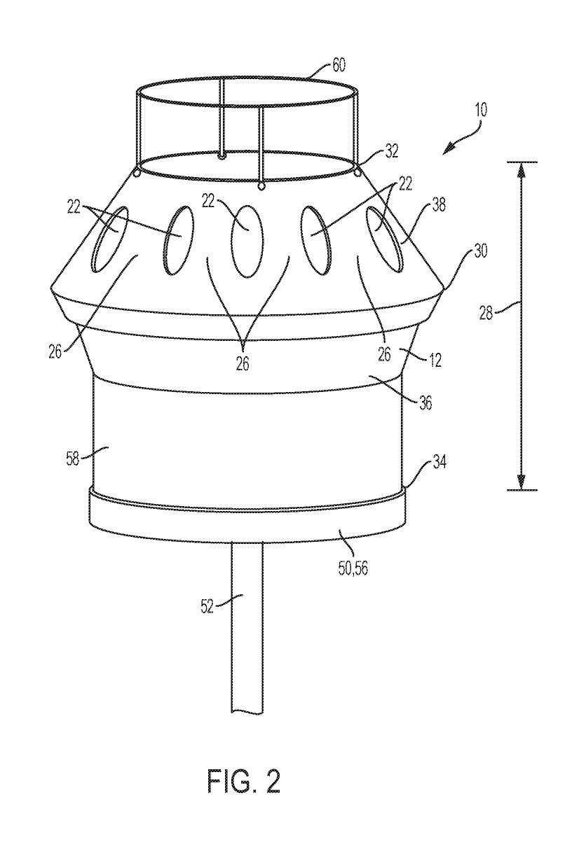

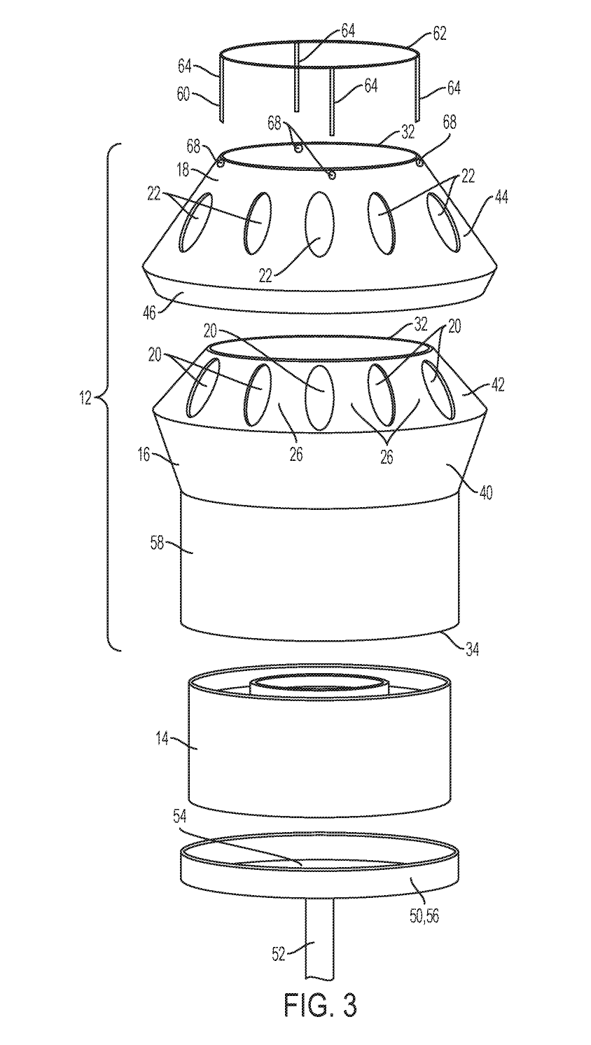

Referring to FIGS. 1-3, a space heater 10 is shown. The space heater 10 may be portable, transportable, or otherwise movable by an outdoor enthusiast or other use (not shown). The space heater 10 may include a main body 12 configured to cover, surround, enclose and/or protect a gel fuel canister 14 when received into the main body 12. The main body 12 may include an inner body 16 and an outer body 18. The inner body 16 may include a first plurality of openings 20. The outer body 18 may include a second plurality of openings 22. The second plurality of openings 22 may align with the first plurality of openings 20 when the outer body 18 is placed over the inner body 16 in a first position, shown in FIG. 1. This creates a plurality of joint openings 24, shown in FIG. 1, in the main body 12. The outer body 18 may be configured to rotate about the inner body 16 to unalign the first plurality of openings 20 with the second plurality of openings 22 to close the plurality of joint openings 24 in a second position, shown in FIG. 2.

In the embodiment shown, the openings 20, 22 of each of the inner body 16 and the outer body 18 may be ovular in shape. In other embodiments, the openings 20, 22 are each circular. Other shapes are contemplated as well, such as square, rectangular, or the like. In still other embodiments, a large number of slits may be provided and disposed about the entirety of each of the inner body 16 and the outer body 18. The openings 20, 22 may each be the same shape, as shown in the Figures. In other embodiments, some openings may have a first shape, and others may have a second, third, fourth, etc. In the embodiment shown, there may be a total of ten openings. However, more or less openings are contemplated. For example, only four openings may be contemplated at ninety degree intervals. In the embodiment shown, gaps 26 located between the openings 20, 22 may have a larger minimum length than the greatest width of the openings 20, 22. This may allow the openings to become completely closed in the second position. In other embodiments, the gaps 26 may have a lesser minimum length than the greatest width of the openings 20, 22 ensuring that the openings always remain at least partially open.

In some embodiments, the outer body 18 may have projections disposed on an interior surface configured to interface with the corresponding channels, bores, holes or openings of the inner body 16 in order to lock the two into place. These projections and corresponding bores may be provided in order to lock the inner body 16 and outer body 18 into place with respect to each other in both the first and second positions.

In the embodiment shown, the main body 12 includes a height 28. A middle location 30 along the height 28 may have a larger circumference than both a top location 32 along the height 28 of the main body 12 and a bottom location 34 along the height 28 of the main body 12. As shown, this may create a saucer shaped main body 12 with a lower portion 36 that is outwardly expanding from the bottom location 34 to the middle location 30. The saucer shaped main body 12 may include an upper portion 38 that is inwardly contracting from the middle location 30 to the top location 32. In the embodiment shown, the openings 20, 22 may be located in the upper portion 38 of the main body 12. In other embodiments, openings may be found in the lower portion 36 or in both portions 36, 38.

The inner body 16 may include both a lower portion 40 and an upper portion 42. However, the outer body 18 may include a full upper portion 44 but may only extend partially downward from the middle location 30 to create a partial lower portion 46. This partial lower portion 46 may, in one embodiment, include slits (not shown) extending from the middle location 30 in order to allow the partial lower portion 46 to bend in an expansive manner to receive a corresponding section of the lower portion 40 of the inner body 16. In other embodiments, the outer body 18 may otherwise expand or receive the inner body 16 in a manner that retains the outer body 18 in the received position.

It should be understood that other shapes for the inner and outer bodies 16, 18 are contemplated. For example, the combined bodies 16, 18 may not have a saucer shape, but instead may be cylindrical. In the embodiment shown, the inner and outer bodies 16, 18, and other components (described hereinbelow) of the space heater 10 may be made of a metallic material. This may provide for sufficient heat transfer in order to radiate heat in an area located about the space heater 10. In other embodiments, there may be a handle or gripping component made from a heat insulating material that prevents heat transfer and does not heat up, such as a ceramic composite or the like. For example, the lower portion 40 of the inner body 16 may be made from this type of material in order to retain this portion 40 cool when the gel fuel canister 14 when the gel fuel canister 14 is lit.

The space heater 10 may further include a base 50 seperable from the main body 12. The gel fuel canister 14 may be configured to rest on the base 50. A stake 52 may extend from the base 50. The stake 52 may be configured to extend into the ground in order to allow the space heater 10 to rest in a position above the ground. The base 50 may include a circular floor 54 and a vertical sidewall 56 extending from the circular floor 54. The vertical sidewall 56 may be configured to receive a bottom circumferential portion 58 of the main body 12. The bottom circumferential portion 58 may include a vertical sidewall that is configured to fit into the vertical sidewall 56 of the base 50 with an interference fit, for example. In other embodiments, the circumference of the circumferential portion 58 may be slightly smaller than the circumference of the vertical sidewall 56 of the base 50. While the shape of the base 50 is shown to be circular, it should be understood that other non-circular shapes are contemplated. A noncircular shape may prevent the bottom circumferential portion 58 from rotating about the base 50. For example, a square, or octagonal (or other poly-sided shape) or an ovular shape would key the base 50 with respect to the inner body 16 to prevent rotation of the inner body 16 about the base 50. Thus, whatever the shape, the bottom circumferential portion 58 may share the same shape as the base 50. This locking of the bottom circumferential portion 58 with the base 50 may allow the outer body 18 to more easily rotate about the inner body 16 without causing rotation of the inner body 16 about the base 50 (which could prevent the rotation of the outer body 18 about the inner body 16). In other embodiments, the inner body 16 may be attached to the base 50 with a locking pin, screw, bolt, or other attachment mechanism.

In the embodiment shown in FIGS. 1-3, the base 50 may include a flat circular floor 54 which is large enough to receive gel fuel canisters having standard dimensions. For example, the circular floor 54 may be configured to receive 7 ounce (3.5 inch diameter) or 13 ounce gel fuel canisters (4 inch diameter). In one embodiment, the main body 12, including the inner body 16 and the outer body 18, may be sized to receive one or both of the 7 ounce or 13 ounce gel fuel canisters. The embodiment depicted includes a main body 12 sized to receive a 7 ounce gen fuel canister 14. However, the main body 12 could be elongated vertically to enable the main body 12 to receive a 13 ounce gel fuel canister.

The space heater 10 may further include a structure 60 located on the top location 32 of the main body 12. The structure 60 may be configured to receive a can of foodstuff (not shown) and prevent the can of foodstuff from being removed from the top location 32 of the main body 12 in a horizontal direction. In other words, the structure 60 may retain the can of foodstuffs on the top 32 of the main body 12 thereby allowing the can of foodstuffs to be heated by the gel fuel canister 14 that may be lit within the main body 12. The structure 60 may be attachable on the top 32 of the main body 12. The structure 60 may include a circular wire 62 positioned above the top 32 of the main body 12 when the structure 60 is attached on the top 32 of the main body 12. The structure 60 may be made from wire and the circular wire 62 may be a wire ring. A plurality of vertical legs 64 may extend from the circular wire 62 and attach the structure 60 to the top 32 of the main body 12. The structure 60 may further include a lower circular wire (not shown) which extends about a base of the structure 60 and rests next to the top 32 of the main body 12 when attached. The vertical legs 64 may extend below this lower circular wire and extend into openings 68 in the top 32 of the main body 12. In the embodiment shown, however, the lower circular wire may not be included, and the vertical legs 64 of the structure may simply extend into the openings 68 at the top 32 of the main body 12. The top 32 of the main body 12 may be a convection plate configured to be heated substantially by the gel fuel canister 14. The top 32 of the main body 12 may further be utilized by an operator to put out the flame once the main body 12 has been removed from the base 50 to expose the gel fuel canister 14.

Other embodiments of attachment structures similar to the structure 60 are contemplated. In one embodiment, the structure 60 is not made of wire, but is a solid cup-holder style attachment. Other attachment mechanisms for the structure are also contemplated, such as bolts, screws, or the like. In other embodiments, the top 32 of the main body 12 may include a large center opening (not shown) configured to allow the flame of the gel fuel canister 14 to directly heat the can of foodstuff.

In still another embodiment, the main body 12 of the space heater 10 may be collapsible. For example, each of the structural components of the inner body 16 and the outer body 18 may collapse into, for example, the base 50. Thus, the base 50, the inner body 16, and the outer body 18 may be collapsed into a pancake-like thin shape. In other embodiments, the space heater 10 and main body 12 may include the same saucer-like shape but may not include two separate bodies 16, 18 but instead may include only a single collapsible structural body. The body 12 may, for example, collapse about a greater circumference middle portion.

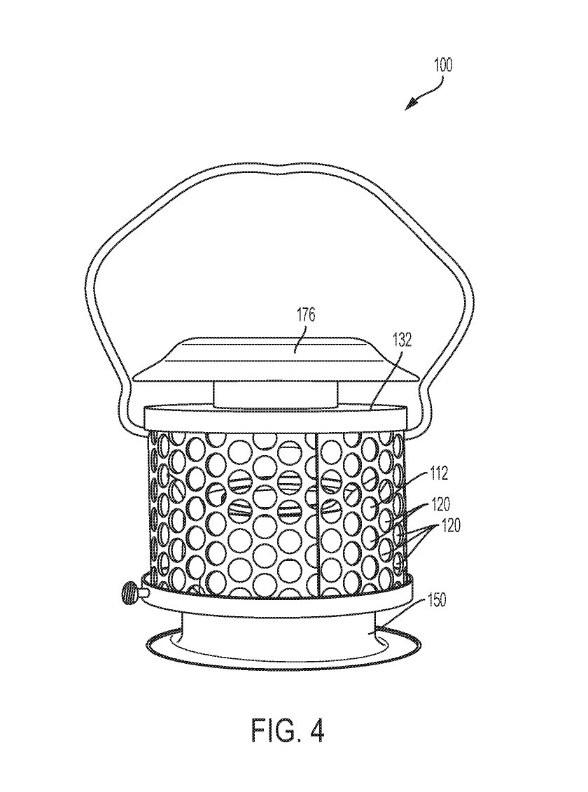

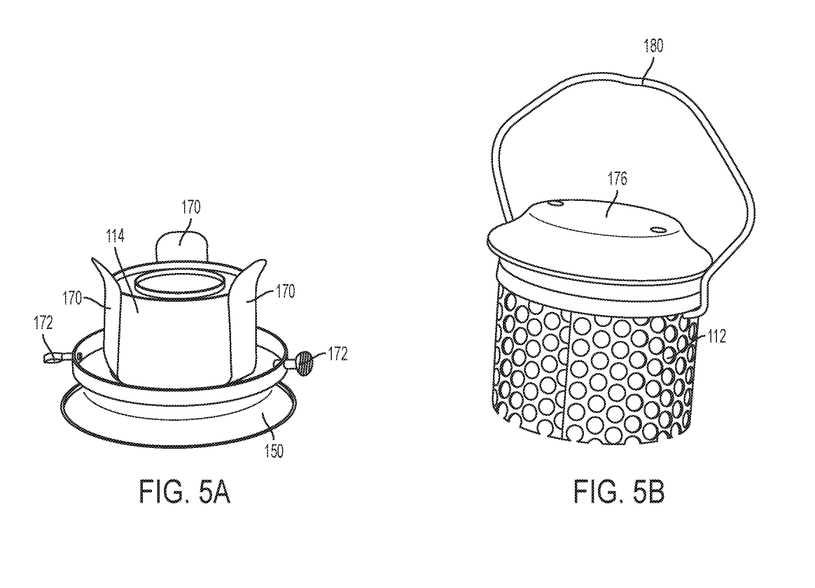

Referring now to the embodiment depicted in FIGS. 4-5B, another embodiment of a space heater 100 is shown. The space heater 100 may include a base 150 and a main body 112. The main body 112 may include a plurality of openings 120 that extend about a circumferential portion of the main body. The openings 120 may be circular and patterned across a substantial portion of the main body 112.

As shown in FIG. 5A, the base 150 may include a plurality of grip elements 170 extending vertically from the base 150. The plurality of grip elements 170 may be tension arms which may securely anchor and hold into place the gel fuel canister 114 into the base 150. The plurality of grip elements 170 may be configured to receive a gel fuel canister 114. Each of the plurality of grip elements 170 may be configured to be deflected by the gel fuel canister 114 when the gel fuel canister 114 is received such that the plurality of grip elements 170 imparts a retaining force on the gel fuel canister 114. In one embodiment, the plurality of grip elements 170 may be configured to deflect enough that both sizes of gel fuel canisters are receivable therein (i.e. 4 inch diameter and 3.5 in diameter). Thus, the grip elements 170 may be attached to the base 150 at locations creating a diameter (if a circle was drawn that extended through each of the attachment locations) greater than a 4 inch diameter. However, the grip elements 170 may extend vertically inward such that a top tip of the grip elements 170 create a diameter (if a circle was drawn that extended through each of the tips) less than 3.5 inches.

The main body 112 is attached to the base 150 with a plurality of threaded screws 172 or hinge type locks which are located on both sides of the main body 112 and which extend through each of the base 150 and the main body 112. The screws 172 may be threaded through the base 150 and extend through one of the plurality of openings 120 of the main body 112. Unlatching the threaded screws 172 may allow an operator or outdoorsman to lift the main body 112 off the base 150 and separate the main body 112 from the base 150. Lifting the main body 112 off the base 150 in this way may expose the gel fuel canister 114.

The base 150 may not include a stake in this embodiment. Rather, the base 150 may be configured to rest on a flat surface. The base 150 may be configured to stabilize the space heater 100 and prevent the space heater 100 from tipping over. Further, the base 150 may be configured to raise the gel fuel canister 114 above the surface upon which the space heater 100 is resting. This may prevent the surface from becoming in direct contact with the heat being generated and absorbed by the main body 112.

Further, the main body 112 may include a cap 176 which may extend through an opening (not shown) in a top 132 of the main body 112. The cap 176 may rest on the top 132 of the main body 112. Removal of the cap 176 may provide access to the opening in the top 132 of the main body in situations where a can of foodstuffs is placed on the top 132 of the main body 112 and needs to be heated. Still further, the main body 112 may include a handle 180 which may be hingedly connected to the main body 112.

The openings 20, 22, 120 of the space heaters 10, 100 may be configured to provide airflow into the internal chamber of the main bodies 12, 112. This air distribution may be necessary to allow the flame to achieve maximum temperature. In other embodiments, other portions of the main bodies 12, 112 may include one or more openings. For example, the lower portion 40 of the inner body 16 may include one or more openings to provide further airflow. However, the main bodies 12, 112 may further be configured to prevent wind from blowing out the flame of the gel fuel canister 14, 114, once lit.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A space heater comprising:
a main body configured to cover a gel fuel canister when received into the main body, the main body including a height and wherein a middle location along the height of the main body has a larger circumference than both a top location along the height of the main body and a bottom location along the height of the main body.

2. The space heater of claim 1, wherein the main body further includes:
an inner body including a first plurality of openings; and
an outer body including a second plurality of openings aligning with the first plurality of openings when the outer body is placed over the inner body in a first position to create a plurality of joint openings in the main body, wherein the outer body is configured to rotate about the inner body to unalign the first plurality of openings with the second plurality of openings to close the plurality of joint plurality of openings in a second position.

3. The space heater of claim 1, further comprising a base seperable from the main body, wherein a gel fuel canister is configured to rest on the base.

4. The space heater of claim 3, wherein a stake extendable into a ground extends from the base.

5. The space heater of claim 3, wherein the base includes a circular floor and includes a vertical sidewall extending from the circular floor, the vertical sidewall configured to receive a bottom circumferential portion of the main body.

6. The space heater of claim 3, wherein the base includes a plurality of grip elements extending vertically from the base, the plurality of grip elements configured to receive the gel fuel canister.

7. The space heater of claim 6, wherein the plurality of grip elements are each configured to be deflected by the gel fuel canister when the gel fuel canister is received such that the plurality of grip elements imparts a retaining force on the gel fuel canister.

8. The space heater of claim 1, wherein the main body is made of a metallic material.

9. The space heater of claim 1, further comprising a structure located on a top of the main body, the structure configured to receive a can of foodstuff and prevent the can of foodstuff from being removed from the top of the main body in a horizontal direction.

10. The space heater of claim 9, wherein the structure is attachable on the top of the main body and wherein the structure includes a circular wire positioned above the top of the main body when the structure is attached on the top of the main body.

11. The space heater of claim 10, wherein the structure is made from wire and circular component is a wire ring, and wherein a plurality of vertical legs extend from the wire ring and attach to the top of the main body.

12. A space heater comprising:
a base, the base including a plurality of grip elements extending vertically from the base, the plurality of grip elements configured to receive a gel fuel canister; and
a main body extending from the base, the main body configured to cover the gel fuel canister when received on the base, the main body including a plurality of openings disposed about the main body.

13. The space heater of claim 12, wherein the plurality of openings are configured to change between an open and a closed state to expose the gel fuel canister.

14. The space heater of claim 12, wherein the plurality of grip elements are each configured to be deflected by the gel fuel canister when the gel fuel canister is received such that the plurality of grip elements imparts a retaining force on the gel fuel canister.

15. The space heater of claim 12, the main body further including:
an inner body including a first plurality of openings; and
an outer body including a second plurality of openings aligning with the first plurality of openings when the outer body is placed over the inner body in a first position to create a plurality of joint openings in the main body, wherein the outer body is configured to rotate about the inner body to unalign the first plurality of openings with the second plurality of openings to close the plurality of joint plurality of openings in a second position.

16. The space heater of claim 12, further comprising a structure located on a top of the main body, the structure configured to receive a can of foodstuff and prevent the can of foodstuff from being removed from the top of the main body in a horizontal direction.

17. A space heater comprising:
a main body configured to cover a gel fuel canister when received on the main body, the main body including a plurality of openings disposed about the main body, the plurality of openings configured to change between an open and a closed state to expose the gel fuel canister; and
a structure located on a top of the main body, the structure configured to receive a can of foodstuff and prevent the can of foodstuff from being removed from the top of the main body in a horizontal direction.

18. The space heater of claim 17, wherein the structure is attachable on the top of the main body and wherein the structure includes a circular component positioned above the top of the main body when the structure is attached on the top of the main body.

19. The space heater of claim 18, wherein the structure is made from wire and circular component is a wire ring, and wherein a plurality of vertical legs extend from the wire ring and attach to the top of the main body.

20. The space heater of claim 17, further comprising a base, the base including a plurality of grip elements extending vertically from the base, the plurality of grip elements configured to receive a gel fuel canister, the main body extending from the base.
